(19) United States
(12) Patent Application Publication
(10) Pub. No.: US 2026/0124569 A1
(43) Pub. Date: May 7, 2026

(54) METHODS AND SYSTEMS TO TRAP PARTICULATES REMOVED FROM SCREEN ASSEMBLIES

(71) Applicant: INTEGRATED GLOBAL SERVICES, INC.

(72) Inventors: Morgan Louis WATSON, Richmond, VA (US); Andrew Scott KLINE, Richmond, VA (US)

(21) Appl. No.: 18/938,707

(22) Filed: Nov. 6, 2024

(51) Int. Cl. B01D 46/10; B01D 46/71

(52) U.S. Cl. CPC B01D 46/103; B01D 46/71

(57) ABSTRACT

Screen systems and methods are provided which remove particulates from a process gas stream. According to the systems and methods, a screen element is provided which is adapted to allow a process gas stream to pass therethrough and thereby remove particulates entrained in the process gas stream. An arcuately (e.g., spirally) shaped particulate trap is positioned along a bottom region of the screen element for receiving and collecting the particulates removed from the process gas stream by the screen element. A pressurized air jet cleaning system may be provided so as to direct pressurized air jets against the surface of the screen element to dislodge particulates therefrom, the pressurized air jets entraining the particulates dislodged from the screen element and directing the particulates to the arcuately shaped particulate trap for collection.

### FIELD

The embodiments disclosed herein relate generally to screen assemblies and methods for removing entrained particulates from a flow of gases. In preferred forms, the embodiments disclosed herein relate to methods and systems which include a static trap for particulates that are removed from screen assemblies through which a particulate-entrained gas flows.

### BACKGROUND

Many industrial processes employ a variety of screen assemblies to remove particulates from process gases. In this regard, typical industrial processes are designed to manipulate gas flows in such a way to reduce emissions. By way of example, some industrial processes employ a grid element that includes a catalyst layer (e.g., a layer of a selective catalytic reduction (SCR) catalyst) to convert emissions in a process gas flow to a more environmentally acceptable chemical species that is released to the atmosphere. Such catalyst layers are comprised of a series of tight grid formations, designed to maximize the surface area for the catalytic actions to take place as the process gas flows through the grid. The openings are typically very small, typically about 4 mm or less, for example as small as 1.5 mm. This means that any particle larger than such opening diameters can cover the opening thereby in time reducing the life and efficiency of the catalyst layer. Providing screen elements upstream of the catalyst layers are therefore an important means to maintain the life and efficiency of the downstream catalyst layer as the screen elements remove particulates from the process gas stream so the downstream catalyst layer does not become contaminated.

It can be appreciated that over time the screen elements will accumulate particulates that need to be removed from the screens so as to not impede the design throughput of the industrial gas. Conventional screen elements thereby will typically employ a series of air cleaning nozzles or equivalent means that are adapted to direct pressurized gas streams of air or steam against the upstream surface of the screen. When activated, therefore, the pressurized gas streams directed against the screen cause the particulates to be dislodged from the screen. The removed particulates will then typically be allowed to fall by gravity to the floor of the process building or allowed to accumulate within the duct containing the screens.

It would therefore be highly desirable if a system could be provided which traps the particulates removed from the screen so as to allow the removed particulates to accumulate which would then also allow the accumulated trapped particulates to be removed and discarded thereby minimizing if not preventing entirely the contamination of the equipment environment. It is towards fulfilling such a need that the embodiments disclosed herein are directed.

### SUMMARY

Broadly, the embodiments disclosed herein relate to a static particulate trap for particulates removed from a screen element. In certain assemblies and methods, a screen element is provided which is adapted to allow a process gas stream to pass therethrough and thereby remove particulates entrained in the process gas stream. An arculately (e.g., spirally) shaped particulate trap is positioned along a bottom region of the screen element for receiving and collecting the particulates removed from the process gas stream by the screen element. Particulates may be removed from the screen element by allowing a gaseous fluid (e.g., air or steam) to impinge on the screen element surface in an angularly downward direction. For example, a pressurized air jet cleaning system adapted to direct pressurized air jets against a surface of the screen element may be provided to dislodge particulates therefrom, the pressurized air jets entraining the particulates dislodged from the screen element and directing the entrained particulates to the arculately shaped particulate trap for collection.

The arcuately shaped particulate trap may include an initial entry section and an upturned arcuate terminal end section. Optionally at least one intermediate arcuate section may be positioned between the initial entry section and the upturned terminal end section. The initial entry section, the upturned terminal end section and if present the at least one intermediate section may be formed as a one-piece arcuately (e.g., spirally) shaped sheet metal structure which may be non-perforated, perforated or formed of a wire mesh. Alternatively the initial entry section, the upturned terminal end section and if present the at least one intermediate section may be formed of individual material sections that may be the same or different from one another, e.g., in terms of material and/or perforation size and/or mesh size. According to some embodiments, the arcuately shaped particulate trap defines the generatrices of an Archimedean spiral shaped surface from 0° to about 540°. As yet another embodiment, the particulate trap may be formed of planar strips or plates such that adjacent ones of the planar strips or plates are joined (welded) to one another in such a manner as to form an open polygonal spiral.

These and other aspects and advantages of the present invention will become more clear after careful consideration is given to the following detailed description of the preferred exemplary embodiments thereof.

### BRIEF DESCRIPTION OF ACCOMPANYING DRAWINGS

The disclosed embodiments of the present invention will be better and more completely understood by referring to the following detailed description of exemplary non-limiting illustrative embodiments in conjunction with the drawings of which:

FIG. 1 is a perspective view of an exemplary screen assembly which includes a particulate trap in accordance with an embodiment of the invention;

FIG. 2 is an enlarged perspective view of a portion of the particulate trap as shown in FIG. 1;

FIG. 3 is an enlarged side elevational view of the particulate trap shown in FIG. 2; and

FIG. 4 is a schematic side elevational view of a particulate trap in accordance with another embodiment of the invention.

### DETAILED DESCRIPTION OF EMBODIMENTS

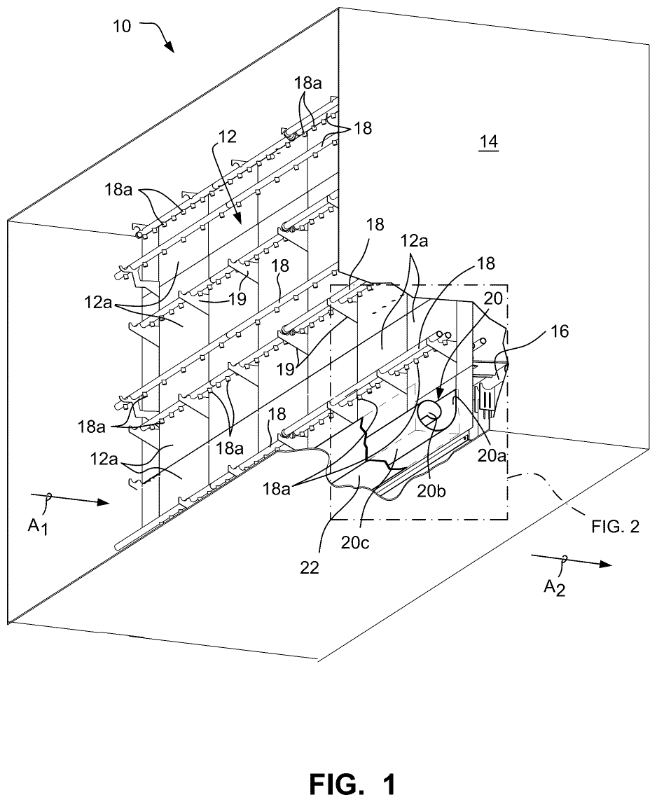

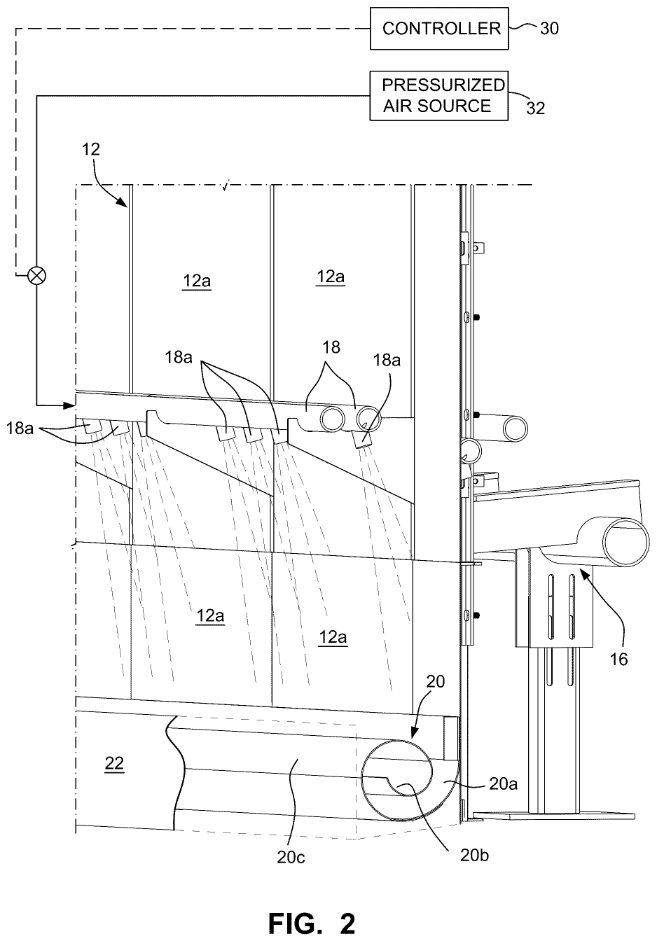

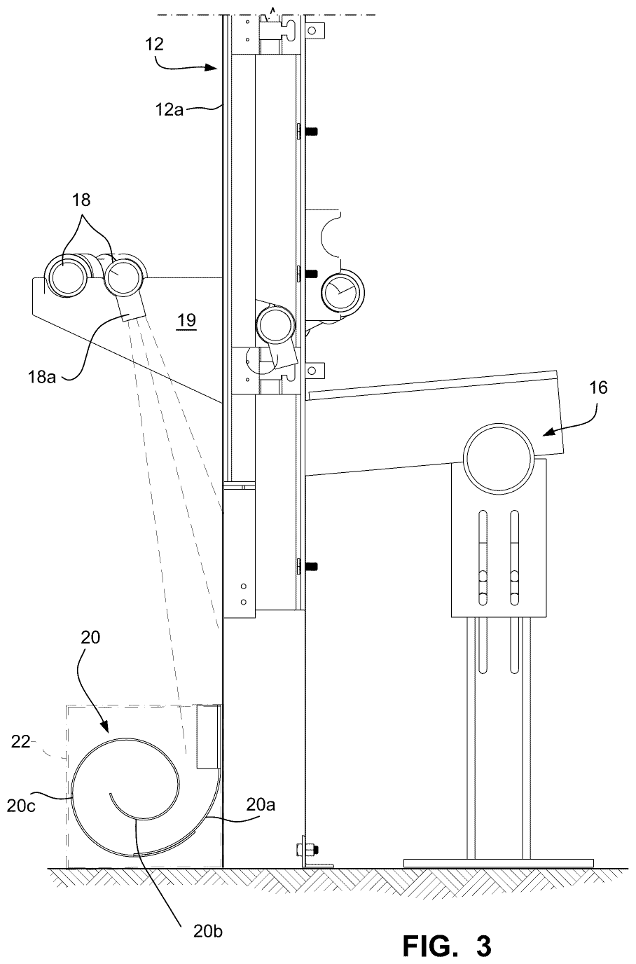

As shown in FIGS. 1-3, an exemplary screen assembly 10 is depicted which includes a screen element 12 housed within a duct 14. Process gas may thus flow within a plenum space of the duct 14 and through the screen element 12 in the direction of arrows A1 and A2 to thereby remove particulates from the gas flow. Thus, particulate-laden gas flow will enter the screen element 12 from an upstream direction (arrow A1) and be passed through the screen element 12 so that particulate-free gas flow exits in a downstream direction (arrow A2). The screen element 12 may comprise individual screen panels (a representative few of which are identified by reference numeral 12a) that are supported in a substantially vertical orientation by a support frame 16 (see FIGS. 2 and 3).

In the embodiment depicted in FIGS. 1-3, the screen assembly 10 is provided with a number of conduits 18 which are positioned via brackets 19 upstream of the screen element 12. The conduits 18 are thereby positioned in front of the screen element 12 so as to extend laterally from one side thereof to the other. Each of the conduits 18 is connected to a source of pressurized air (see FIG. 2) and includes a series of nozzles (a representative few of which are identified by reference numeral 18a) to direct jets of the pressurized air onto the surface of the screen element 12 in an angularly downward direction to thereby dislodge particulates that were removed from the process gas stream by the screen element 12.

It will be appreciated by those skilled in this art that alternative means other than the pressurized air jet nozzles 18a as depicted may be provided to remove the particulates from the screen element 12. For example, the particulates may be removed from the screen element 12 by means of so-called soot blowers which may direct air or steam under pressure against the surface of the screen element. As a further alternative, the flow of the process gas itself may be employed to remove particulates from the screen element 12 by angularly orienting the screen element 12 relative to the flow of process gas so it angularly impinges on the surface of the screen element 12 thereby dislodging particulates therefrom.

Important to the embodiments disclosed herein, the screen element 12 will include a static arcuately shaped particulate trap 20 that may be housed within an enclosure 22 and extends laterally from one side to the other at the bottom edge region of the screen element 12. As is shown, the particulate trap 20 may be generally spirally shaped, e.g., a structural component which defines in general the generatrices of a spirally shaped surface. In some preferred embodiments, the particulate trap defines the generatrices of an Archimedean spiral shaped surface through 540°. The particulate trap 20 may thus define an initial entry section 20a starting at the 0° portion of the spiral to accept therein the particulates removed from the screen element 12 by the jets of pressurized air issuing from the nozzles 18a.

The pressurized air with entrained particulates removed from the screen element 12 will thereby flow along the spiral surface of the trap 20. It will be appreciated that the velocity of the pressurized air with entrained particulates decreases as the air moves along the spiraled surface of the trap 20. The velocity of the pressurized air will thus be sufficiently reduced when it reaches the upturned arcuate terminal end section 20b of the trap 20 (i.e., the section of the trap 20 from about the 360° to about the 540° portion of the spiral) to thereby allow the particulates to be deposited therein. Thus, the upturned terminal end section 20b of the trap will serve as a collector for the particulates removed from the screen element 12. The collected particulates in the upturned terminal end region 20b may then be removed from one of the ends by conventional cleaning means, e.g., vacuum removal such via the system disclosed in U.S. Pat. No. 9,745,878 (the entire content of which is expressly incorporated hereinto by reference). Such periodic cleaning may be accomplished without equipment shutdown (i.e., on-line cleaning). The enclosure 22 may also be closed with a suitable removable cover plate (not shown).

The trap 20 may be formed of a one-piece solid or perforated sheet metal material or a wire mesh of sufficient thickness to retain the spiral shape. If the trap 20 is formed of a spiraled perforated sheet metal or a wire mesh the perforation openings/mesh sizes are sufficiently small to prevent particulates from passing therethrough. Alternatively the trap 20 may be formed of plural curved sheet metal sections, for example, the entry and terminal end sections 20a and 20b, respectively and optionally at least one intermediate section 20c. The sections 20a-20c may be formed of the same or different sheet metal materials and/or screen mesh. For example, the trap 20 may include the entry and terminal sections 20a and 20b with an intermediate section 20c each having a progressively larger perforation/mesh size.

In use, the screen assembly 10 will be placed in services so as to remove entrained particulates in a process gas flowing through the duct 14 in the direction of arrow A1 so that the screen element 12 housed within the duct 14 can remove the entrained particulates therefrom. Particulate-free process gas can then proceed downstream of the screen element 12 in the direction of arrow A2. As may be periodically determined either manual or by suitable process control sensors (e.g., sensing an increased pressure drop across the screen element 12 due to accumulated particulates therein removed from the process gas), a controller 30 will issue a signal to open a valve 32 to allow compressed air to flow into the conduits 18 and be discharged as jets via the nozzles 18a to thereby impinge against the surface of the screen element 12. The compressed air jets will thereby dislodge the particulates from the screen element 12 and entrain the dislodged particulates therein. The flow of compressed air with the entrained particulates will then enter the trap member 20 and travel along the spirally shaped surface thereof. As noted previously, the velocity of the compressed air will decrease as it travels along the spirally shaped surface of the trap member 20 such that the entrained particulates will eventually be deposited in the upturned terminal end section 20b where they are allowed to collect. Subsequently the collected particulates in the upturned terminal end section 20b can be removed (e.g., by means of vacuum).

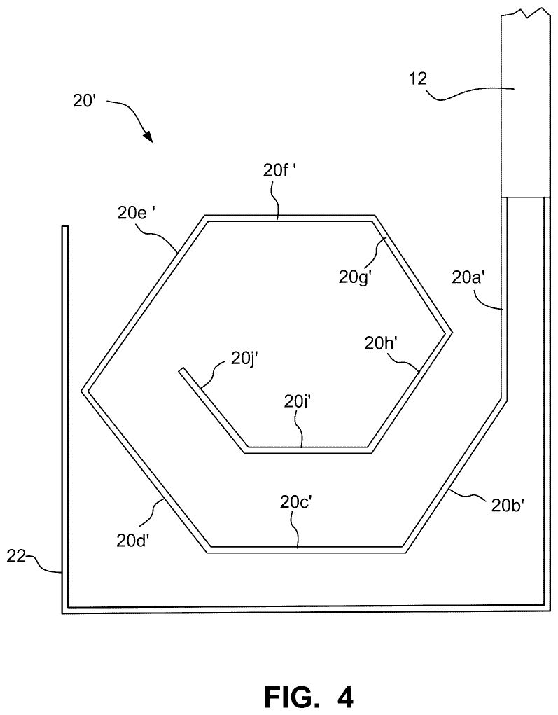

An alternative embodiment of a particulate trap 20′ is depicted in accompanying FIG. 4. As is shown, the particulate trap 20′ is in the form of an open polygonal spiral composed of a series of adjacent elongate strips or plates 20a′ through 20j′ that are joined (welded) together along lengthwise edges thereof. The open polygonal spiral form of the particulate trap 20′ will therefore terminate in an upturned terminal end region comprised of conjoined adjacent strips or plates 20h′-20j′ which receive and trap the particulates removed from the screen element 12.

While reference has been made to particular embodiments of the invention, various modifications within the skill of those in the art may be envisioned. For example, the Figures herein depict the trap members 20 and 20′ being positioned within a supplemental enclosure 22 within the plenum space of the duct 14 and at the bottom thereof. The enclosure 22 may be omitted in such an arrangement if desired. Further, the enclosure 22 and the trap members 20 and 20′ could be positioned below the bottom of the duct 14 exterior thereof. Therefore, it is to be understood that the invention is not to be limited to the disclosed embodiments, but on the contrary, is intended to cover various modifications and equivalent arrangements included within the spirit and scope thereof.

What is claimed is:

1. A screen system to remove particulates from a process gas stream, the screen system comprising:
a screen element which allows a process gas stream to pass therethrough to thereby allow particulates entrained in the process gas stream to be removed therefrom; and
a generally spirally shaped particulate trap positioned along a bottom region of the screen element for receiving and collecting the particulates removed from the process gas stream by the screen element.

2. The screen system according to claim 1, wherein the particulate trap is comprised of a spirally shaped sheet metal component selected from the group consisting of perforated sheet metal, non-perforated sheet metal and wire mesh.

3. The screen system according to claim 2, wherein the spirally shaped sheet metal component is comprised of a one-piece sheet metal component or is formed of multiple sheet components that may be the same or different from one another.

4. The screen system according to claim 1, wherein the particulate trap is comprised of a series of elongated planar metal strips that are joined to one another such that the particulate trap forms a generally open polygonal spiral.

5. The screen system according to claim 1, further comprising a pressurized air jet cleaning system adapted to direct pressurized air jets against a surface of the screen element to dislodge particulates therefrom, the pressurized air jets entraining the particulates dislodged from the screen element and directing the particulates to the spirally shaped particulate trap for collection.

6. The screen system according to claim 1, wherein the particulate trap includes an initial entry section and an upturned arcuate terminal end section.

7. The screen system according to claim 6, wherein the particulate trap includes at least one intermediate arcuate section between the initial entry section and the upturned terminal end section.

8. The screen system according to claim 7, wherein the particulate trap is formed of a non-perforated metal sheet, a perforated metal sheet or a wire mesh.

9. The screen system according to claim 8, wherein the arcuately shaped particulate trap is spirally shaped and includes an initial entry section and an upturned arcuate terminal end section which may be the same or different from one another.

10. The screen system according to claim 9, wherein the spirally shaped particulate trap includes at least one intermediate arcuate section between the initial entry section and the upturned terminal end section.

11. The screen system according to claim 1, wherein the particulate trap defines generatrices of an Archimedean spiral shaped surface.

12. A screen assembly comprising:
a duct to direct a process gas stream; and
the screen system according to claim 1 operatively positioned relative to the duct to allow the process gas stream to pass therethrough and to thereby remove particulates entrained in the process gas stream.

13. The screen assembly according to claim 12, further comprising a pressurized air jet cleaning system adapted to direct pressurized air jets against a surface of the screen element to dislodge particulates therefrom, the pressurized air jets entraining the particulates dislodged from the screen element and directing the particulates to the arcuately shaped particulate trap for collection.

14. The screen assembly according to claim 13, wherein the particulate trap includes an initial entry section and an upturned arcuate terminal end section.

15. The screen assembly according to claim 14, wherein the particulate trap includes at least one intermediate arcuate section between the initial entry section and the upturned arcuate terminal end section.

16. The screen assembly according to claim 12, wherein the particulate trap is formed of a non-perforated metal sheet, a perforated metal sheet or a wire mesh.

17. The screen assembly according to claim 12, further comprising an enclosure for the arcuately shaped particulate trap.

18. A method of cleaning particulates from a screen element comprising:
(a) dislodging the particulates from the screen element; and
(b) positioning an arcuately shaped particulate trap along a bottom region of the screen element for receiving and collecting the particulates dislodged therefrom the screen element.

19. The method according to claim 18, wherein step (a) comprises:
(a1) directing a pressurized air jet against a surface of the screen element to dislodge particulates therefrom, and
(a2) entraining the particulates dislodged from the screen element in the air jet, and
(a3) directing the air jet and entrained particulates to the spirally shaped particulate trap for collection.

20. The method according to claim 19, wherein step (a3) includes allowing the arcuately shaped particulate trap to decrease a velocity of the air jet and entrained particulates as it progresses from an initial entry section thereof to an upturned terminal end section thereof such that the particulates are deposited and collected in the upturned arcuate terminal end section.

21. The method according to claim 18, further comprising periodically removing the particulates collected in the upturned terminal end section.
